(19) United States
(12) Patent Application Publication
(10) Pub. No.: US 2026/0292456 A1
(43) Pub. Date: Sep. 24, 2026

(54) SYSTEMS AND METHODS FOR MANAGING COMMUNICATION-RELATED TRAFFIC

(71) Applicant: Ford Global Technologies, LLC, Dearborn, MI (US)

(72) Inventors: Ryan O'Gorman, Beverly Hills, MI (US); Stuart C. Salter, White Lake, MI (US); Krishna Bandi, Novi, MI (US); Vyas Darshan Shenoy, Canton, MI (US); Brendan Diamond, Naples, FL (US); Mario Anthony Santillo, Canton, MI (US)

(73) Assignee: Ford Global Technologies, LLC, Dearborn, MI (US)

(21) Appl. No.: 19/086,814

(22) Filed: Mar. 21, 2025

(51) Int. Cl. H04W 4/44; G08G 1/01; H04W 28/02

(52) U.S. Cl. CPC H04W 4/44; G08G 1/0129; H04W 28/0247

(57) ABSTRACT

A method includes the generation of one or more classifications of use associated with marshaling a plurality of vehicles, the assignment of each vehicle of the plurality of vehicles to a category of the one or more classifications, the association of assigned vehicles within each category of the one or more classifications, and the assignment of one vehicle of the associated vehicles to be a receiving vehicle configured to receive one or more signals from an infrastructure system and broadcast the one or more signals to other vehicles of the associated vehicles.

### FIELD

The present disclosure relates to managing communication-related traffic, and more particularly, optimizing transmission and receipt of one or more signals exchanged between a central server and one or more vehicles.

### BACKGROUND

The statements in this section merely provide background information related to the present disclosure and may not constitute prior art.

Vehicle management systems typically rely on cellular communication originating from one or more vehicles in order to manage the one or more vehicles. Such management includes locally-based cellular nodes having to filter through various forms of communication in order to efficiently manage the one or more vehicles. However, the various forms of communication received at the locally-based cellular nodes can be overwhelming to the system (e.g., overload the system) and result in one or more communication-related issues such as communication delays, operational disruptions, or a hindrance of traditional communications/data traffic from efficiently passing through a site firewall without drops or other issues.

The present disclosure addresses these and other issues related to the management of communication-related traffic.

### SUMMARY

This section provides a general summary of the disclosure and is not a comprehensive disclosure of its full scope or all of its features.

The present disclosure provides a method comprising: generating, by an infrastructure system, one or more classifications of use associated with marshaling a plurality of vehicles; assigning each vehicle of the plurality of vehicles to a category of the one or more classifications based on a location of each vehicle, a duration of state associated with each vehicle, one or more communication requirements associated with each vehicle, or a combination thereof; associating the assigned vehicles within each category of the one or more classifications based on one or more communication-related scores; and assigning one vehicle of the associated vehicles to be a receiving vehicle, wherein the receiving vehicle is configured to receive one or more signals from the infrastructure system and broadcast the one or more signals to other vehicles of the associated vehicles; wherein generating the one or more classifications of use includes: storing one or more historical commands associated with each vehicle of the plurality of vehicles; and predicting, based on the one or more historical commands, one or more feedforward commands corresponding to a future route each vehicle of the plurality of vehicles is to travel or a parking area each vehicle of the plurality of vehicles is to park; wherein the one or more classifications of use include at least one of a monitoring state, a moving state, a transition state, and a station operation; wherein broadcasting the one or more signals from the receiving vehicle to the other vehicles of the associated vehicles is based on a cellular communication traffic exceeding a calibrated threshold; further comprising: determining whether a cellular communication traffic is below a calibrated threshold; and transmitting, from the infrastructure system, the one or more signals to each vehicle of the associated vehicles in response to determining that the cellular communication traffic is below the calibrated threshold; wherein the one or more communication-related scores include a regularity score, a severity score, or a combination thereof; and further comprising: assigning the regularity score to each vehicle of the plurality of vehicles; and assigning the severity score to each vehicle of the plurality of vehicles.

The present disclosure provides a system comprising: an infrastructure system configured to: generate one or more classifications of use associated with marshaling a plurality of vehicles, assign each vehicle of the plurality of vehicles to a category of the one or more classifications based on a location of each vehicle, a duration of state associated with each vehicle, one or more communication requirements associated with each vehicle, or a combination thereof, associate the assigned vehicles within each category of the one or more classifications based on one or more communication-related scores, assign one vehicle of the associated vehicles to be a receiving vehicle, and transmit one or more signals to the receiving vehicle; and the receiving vehicle is configured to: receive the one or more signals from the infrastructure system, and broadcast the one or more signals to other vehicles of the associated vehicles; wherein the infrastructure system configured to generate the one or more classifications of use is further configured to: store one or more historical commands associated with each vehicle of the plurality of vehicles; and predict, based on the one or more historical commands, one or more feedforward commands corresponding to a future route each vehicle of the plurality of vehicles is to travel or a parking area each vehicle of the plurality of vehicles is to park; wherein the one or more classifications of use include at least one of a monitoring state, a moving state, a transition state, and a station operation; wherein broadcasting the one or more signals from the receiving vehicle to the other vehicles of the associated vehicles is based on a cellular communication traffic exceeding a calibrated threshold; wherein the infrastructure system is further configured to: determine whether a cellular communication traffic is below a calibrated threshold; and transmit the one or more signals to each vehicle of the associated vehicles in response to determining that the cellular communication traffic is below the calibrated threshold; wherein the one or more communication-related scores include a regularity score, a severity score, or a combination thereof, and wherein the infrastructure system is further configured to: assign the regularity score to each vehicle of the plurality of vehicles; and assign the severity score to each vehicle of the plurality of vehicles; and wherein each vehicle of the other vehicles of the associated vehicles is configured to: receive the broadcasted one or more signals from the receiving vehicle; determine one or more anomalies within the broadcasted one or more signals; and establish a communication link with the infrastructure system in response to the determination of the one or more anomalies, wherein the communication link provides for direct communication of the one or more signals between each vehicle of the other vehicles of the associated vehicles and the infrastructure system.

The present disclosure provides one or more non-transitory computer-readable media storing processor-executable instructions that, when executed by at least one processor, cause the at least one processor to: generate, by an infrastructure system, one or more classifications of use associated with marshaling a plurality of vehicles; assign each vehicle of the plurality of vehicles to a category of the one or more classifications based on a location of each vehicle, a duration of state associated with each vehicle, one or more communication requirements associated with each vehicle, or a combination thereof; associate the assigned vehicles within each category of the one or more classifications based on one or more communication-related scores; and assign one vehicle of the associated vehicles to be a receiving vehicle, wherein the receiving vehicle is configured to receive one or more signals from the infrastructure system and communicate the one or more signals to other vehicles of the associated vehicles; wherein the at least one processor caused to generate the one or more classifications of use is further caused to: store one or more historical commands associated with each vehicle of the plurality of vehicles; and predict, based on the one or more historical commands, one or more feedforward commands corresponding to a future route each vehicle of the plurality of vehicles is to travel or a parking area each vehicle of the plurality of vehicles is to park; wherein the one or more classifications of use include at least one of a monitoring state, a moving state, a transition state, and a station operation; wherein broadcasting the one or more signals from the receiving vehicle to the other vehicles of the associated vehicles is based on a cellular communication traffic exceeding a calibrated threshold; wherein the at least one processor is further caused to: determine whether a cellular communication traffic is below a calibrated threshold; and transmit, from the infrastructure system, the one or more signals to each vehicle of the associated vehicles in response to determining that the cellular communication traffic is below the calibrated threshold; and wherein the one or more communication-related scores include a regularity score, a severity score, or a combination thereof, and wherein the at least one processor is further caused to: assign the regularity score to each vehicle of the plurality of vehicles; and assign the severity score to each vehicle of the plurality of vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 illustrates an implementation of a system for signal distribution in accordance with one or more embodiments of the present disclosure;

FIG. 4 is a flowchart illustrating an example method for managing communication-related traffic in accordance with one or more embodiments of the present disclosure; and

FIG. 5 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide systems and methods for managing communication-related traffic within a marshaling environment that includes batching or grouping vehicles together with similar operation(s) and flagging special occurrences for dispatch, thereby enhancing the efficiency of a cell system (e.g., a cellular node system) associated with the marshaling environment, as is further described herein.

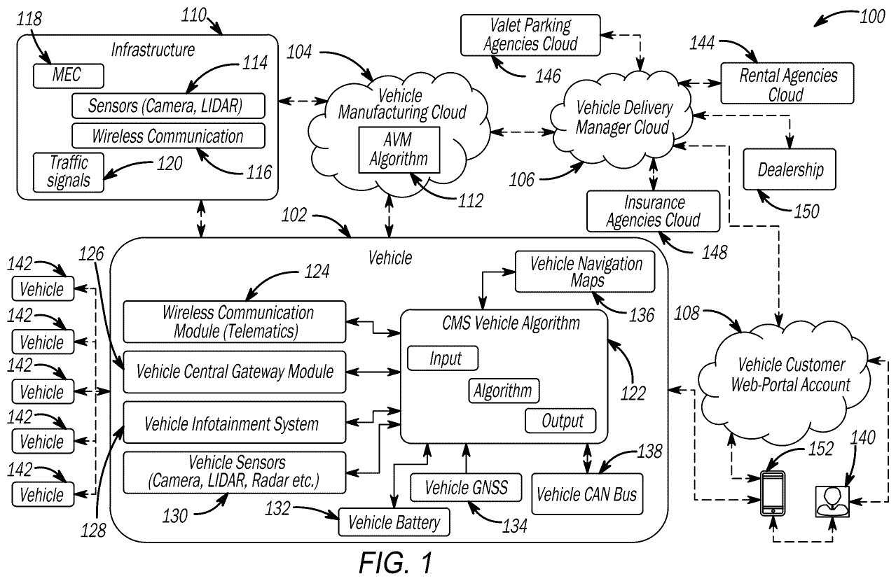

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

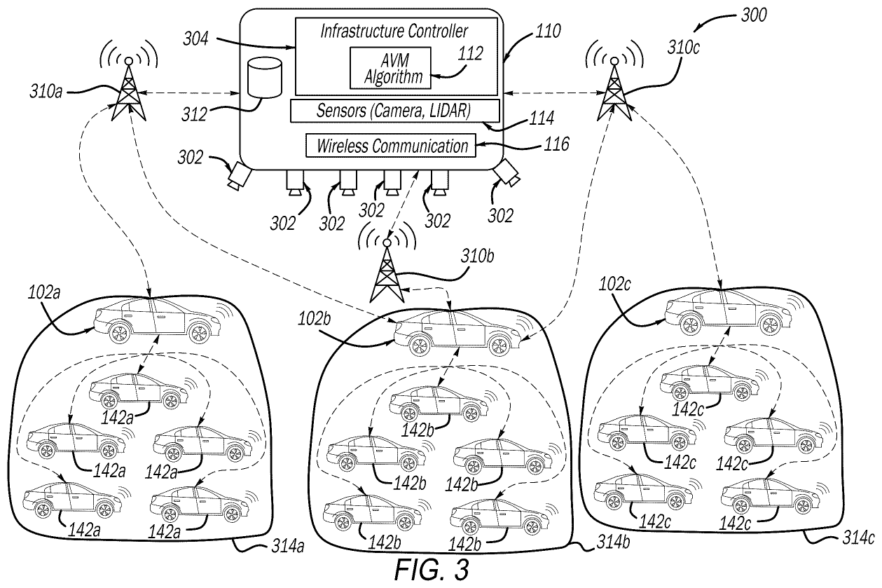

The vehicle manufacturing cloud system 104 can include an infrastructure-side AVM algorithm 112. However, it is understood that the infrastructure system 110 can include the infrastructure-side AVM algorithm 112 as well, as is shown in FIG. 3. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment. For example, the marshaling environment can represent a plant marshaling setting, an automated charging setting, a depot marshaling setting, a parking setting, among others. As an example, the plant marshaling setting can include an instance wherein just-built vehicles are moved through end-of-line testing at a vehicle assembly plant via overhead vision sensing (e.g., via a set of infrastructure sensors 302 as shown in FIG. 3). As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the parking setting can include an instance wherein vehicles are moved through underground or covered parking environments with a potentially inconsistent communication network such as a global navigation satellite system.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is also configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes a sensor component 114, a wireless communication component 116, a multi-access edge computing (MEC) system 118, and one or more traffic signals 120. It is understood that the MEC system 118 is configured to support communication between the wireless communication component 116 and the vehicle 102. It is further understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth® to communicate with the one or more vehicles.

The wireless communication component 116 also communicates with the sensor component 114 that is configured to communicate with and/or manage the set of infrastructure sensors 302, as is described herein. In one or more examples, the sensor component 114 is also configured to perform one or more localization functions associated with marshaling the one or more vehicles such as, but not limited to, perception, path-planning, detection, controls, and/or receiving and analyzing response(s) from each vehicle of the one or more vehicles.

The wireless communication component 116 is also in communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include, but is not limited to, a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits a wall or another vehicle and is then reflected back to the vehicle 102. Based on the amount of time it takes for the sound wave to return to the vehicle 102, the vehicle 102 can determine the distance between the one or more vehicle sensors 130 and the wall or the other vehicle. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the wall or the other vehicle and is then reflected back to the vehicle 102. Based on the amount of time it takes for the electromagnetic waves to return to the vehicle 102, the vehicle 102 can determine a range, velocity, and angle of the vehicle 102 relative to the wall or the other vehicle.

The one or more vehicle sensors 130 communicate information associated with the position and/or distance at which the vehicle 102 is located relative to the wall or the other vehicle to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as, but not limited to, the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agency cloud system 144, a valet parking agency cloud system 146, an insurance agency cloud system 148, and/or a dealership system 150. The vehicle delivery manager cloud system 106 is configured to facilitate the delivery of the one or more vehicles to, for example, any of a rental agency (not shown) associated with the rental agency cloud system 144, a valet parking agency (not shown) associated with the valet parking agency cloud system 146, an insurance agency (not shown) associated with the insurance agency cloud system 148, and/or the dealership system 150. The vehicle delivery manager cloud system 106 also wirelessly communicates with the vehicle customer web-portal account cloud system 108. It should be understood that other cloud systems can be included, in one or more examples.

The vehicle delivery manager cloud system 106 wirelessly communicates with a user device 152 such as, but not limited to, a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agency cloud system 144, the valet parking agency associated with the valet parking agency cloud system 146, the insurance agency associated with the insurance agency cloud system 148, and/or the dealership system 150.

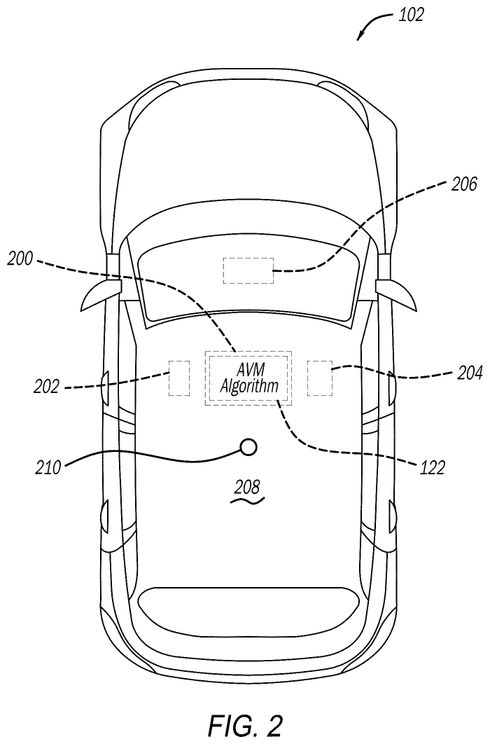

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally includes a vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The plurality of on-board sensors 204 includes a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensor(s) affixed to one or more bumpers of the vehicle(s) 102 that may provide locations of the object(s) relative to the location of each of the vehicle(s) 102. As yet another example, one or more of the plurality of on-board sensors 204 can be configured to monitor one or more functionalities associated with one or more internally-based components of the vehicle(s) 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be programmed to determine a current vehicle location based on location coordinates (e.g., GPS coordinates) received from the vehicle(s) 102 indicative of a location of the vehicle(s) 102 from a GPS sensor (not shown).

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programmed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for various communications on a vehicle communication network (not shown) that can include a bus in the vehicle(s) 102 such as a CAN bus, or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as is discussed below, various other controllers and/or sensors provide data to the vehicle controller 200 via the vehicle communication network.

In addition, the vehicle controller 200, via the vehicle-side AVM algorithm 122, is also configured to communicate through a vehicle-to-infrastructure communication network, such as communicating with an infrastructure controller (e.g., an infrastructure controller 304 as shown in FIG. 3). The vehicle controller 200, via the vehicle-side AVM algorithm 122, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The HMI 206 is configured to receive information from the human operator during operation of the vehicle(s) 102. Moreover, the HMI 206 is configured to present information to the human operator, such as an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

In one or more embodiments, FIG. 3 shows a system 300 configured to provide a means for the infrastructure system 110 to optimize or otherwise control the distribution of communication-related signals (e.g., including, but not limited to, cellular signals) to any number of vehicles (e.g., the vehicle 102 and/or the one or more additional vehicles 142). In one or more examples, while the communication-related signals are distributed (e.g., from the infrastructure system 110) to vehicles located within the marshaling environment, it is understood that the infrastructure system 110 can distribute the communication-related signals to vehicles located outside the marshaling environment as well.

In one or more embodiments, the infrastructure system 110 includes the sensor component 114 that communicates with the set of infrastructure sensors 302. The set of infrastructure sensors 302 are configured to monitor the movement of the vehicle 102 (e.g., and/or the one or more additional vehicles 142) as the vehicle 102 (e.g., and/or the one or more additional vehicles 142) moves through the marshaling environment. The infrastructure system 110 also includes the wireless communication component 116 that provides a means for communication between the infrastructure system 110 and one or more communication nodes 310a-310c. However, it is understood that the wireless communication component 116 also provides a means for direct communication between the infrastructure system 110 and the vehicle 102 (e.g., and/or the one or more additional vehicles 142).

In one or more examples, movement of the vehicle 102 (e.g., and/or the one or more additional vehicles 142) through the manufacturing environment is monitored based on a field of view of the set of infrastructure sensors 302. As another example, movement of the vehicle 102 (e.g., and/or the one or more additional vehicles 142) through the manufacturing environment is also monitored based on one or more infrastructure marshaling messages (e.g., IMMs) and one or more vehicle marshaling messages (e.g., VMMs) exchanged between the vehicle 102 (e.g., and/or the one or more additional vehicles 142) and the infrastructure system 110.

Additionally, the infrastructure system 110 includes the infrastructure controller 304. The infrastructure controller 304 is configured to centrally control an operation of the vehicle 102 (e.g., and/or the one or more additional vehicles 142). For example, the operation of the vehicle 102 (e.g., and/or the one or more additional vehicles 142) includes propulsion, braking, and/or steering of the vehicle 102 (e.g., and/or the one or more additional vehicles 142). It is understood that the infrastructure controller 304 may be disposed within the infrastructure system 110 or externally located relative to the infrastructure system 110. The infrastructure controller 304 includes the infrastructure-side AVM algorithm 112 that is configured to facilitate communication between the infrastructure controller 304 and the vehicle controller 200 associated with the vehicle 102 (e.g., and/or the one or more additional vehicles 142).

In one or more embodiments, the infrastructure-side AVM algorithm 112 is configured to create (e.g., generate) one or more classifications of use associated with one or more operations related to each vehicle located within communicative range from the infrastructure system 110 and/or the one or more communication nodes 310a-310c. As an example, each of the one or more classifications corresponds to a predefined use that can include a monitoring state, a moving state, a transition state, or a station operation. However, it is understood that the predefined use is not limited to the monitoring state, the moving state, the transition state, and/or the station operation and can include any other state or operation related to a functionality of an automated vehicle or control of the automated vehicle by a central server.

In one or more examples, the creation of the one or more classifications of use can be based on one or more historical commands (e.g., one or more IMMs and/or VMMs) associated with the vehicle 102 (e.g., and/or the one or more additional vehicles 142). However, it is understood that the one or more historical commands can originate from one or more marshaling commands transmitted (e.g., from the infrastructure system 110 and via the one or more IMMs) to one or more previously marshaled vehicles. In one or more examples, the previously marshaled vehicles can include, but are not limited to, vehicles that have already moved through a vehicle assembly portion of the marshaling environment that can include various calibration stations. As another example, the infrastructure system 110 is configured to store the one or more historical commands, regardless of the origination of the one or more commands, within a database 312. While the database 312 is depicted as being disposed internally within the infrastructure system 110, it is understood that the database 312 can be disposed externally from the infrastructure system 110 as well.

In one or more embodiments, the infrastructure-side AVM algorithm 112 is also configured to transmit one or more feedforward commands (e.g., via the one or more IMMs) to the vehicle 102 (e.g., and/or the one or more additional vehicles 142). In one or more examples, a determination of the one or more feedforward commands is based on the one or more historical commands, lot availability associated with the marshaling environment, build expectations (e.g., vehicle features, vehicle trim, vehicle sensors, etc.) associated with the vehicle 102 (e.g., and/or the one or more additional vehicles 142), or a combination thereof. It is understood, however, that the determination of the one or more feedforward commands can be based on any aspect of a vehicle assembly process, the marshaling environment itself, and/or the vehicle (e.g., and/or the one or more additional vehicles 142).

In one or more embodiments, the infrastructure-side AVM algorithm 112 is also configured to predict the one or more feedforward commands based at least on the one or more historical commands and through the utilization of one or more machine learning techniques or other artificially intelligent techniques. In one or more examples, the prediction of the one of more feedforward commands can correspond to a future route determined as optimal for the vehicle 102 (e.g., and/or the one or more additional vehicles 142) to move across the marshaling environment. As another example, the optimal route can be considered to be, but is not limited to, a fastest route to a predefined destination of the vehicle 102 (e.g., the one or more additional vehicles 142) and/or a route with a least number of obstacles (e.g., other vehicles, buildings, machinery, etc.) compared to any other route option. In one or more examples, the predefined destination can include, but is not limited to, a parking spot, a charging station, or a workstation. It is also understood that the predefined destination can include any destination within the marshaling environment.

The infrastructure-side AVM algorithm 112 is further configured to group each individual classification of the one or more classifications into categories based on a location of the vehicle 102 (e.g., and/or the one or more additional vehicles 142), a duration of state associated with the vehicle 102 (e.g., and/or the one or more additional vehicles 142), one or more communication requirements associated with the vehicle 102 (e.g., and/or the one or more additional vehicles 142), or a combination thereof. However, it is understood that the categorization or association of each individual classification of the one or more classifications can be based on any feature or state related to a functionality or operation of an automated vehicle.

In one or more embodiments, the one or more classifications, as well as the various categories associated with the one or more classifications, can indicate an operational compatibility of a vehicle in relation to other vehicles. For example, a vehicle is operationally compatible with another vehicle in an instance wherein each vehicle can move across the marshaling environment reliant on communication with one another, rather than communication with the infrastructure system 110. In one or more examples, a grouping of vehicles can correspond to each category within the one or more classifications. In one or more examples, as illustrated in FIG. 3, a first group of vehicles 314a includes a first vehicle 102a as well as one or more additional vehicles 142a; a second group of vehicles 314b includes a second vehicle 102b as well as one or more additional vehicles 142b; and a third group of vehicles 314c includes a third vehicle 102c as well as one or more additional vehicles 142c.

In one or more examples, the number of vehicles included within a grouping of vehicles is based on a calibrated threshold. For example, the calibrated threshold is a ratio of a number of vehicles directly communicating with the central server (e.g., the infrastructure system 110) to a number of vehicles not directly communicating with the central server that can correspond to a predefined signal quality. As another example, one or more conditions defining a point that the calibrated threshold is met or exceeded can cause the ratio to be adjusted. As a further example, and in a case wherein communication-related traffic (e.g., cellular traffic) is busy, the infrastructure system 110 is configured to communicate to a hub vehicle (e.g., the first vehicle 102a, the second vehicle 102b, and/or the third vehicle 102c) within the grouping of vehicles (e.g., the first group of vehicles 312a, the second group of vehicles 312b, and/or the third group of vehicles 312c) for a defined number of vehicles, such as every ten vehicles. As yet another example, and in a case wherein communication-related traffic is less busy, the infrastructure system 110 is configured to communicate to the hub vehicle (e.g., the first vehicle 102a, the second vehicle 102b, and/or the third vehicle 102c) within the grouping of vehicles (e.g., the first group of vehicles 314a, the second group of vehicles 314b, and/or the third group of vehicles 314c) for a different defined number of vehicles, such as every five vehicles. In one or more examples, and in a case wherein the calibrated threshold is not exceeded, the infrastructure system 110 is configured to communicate directly with each vehicle within the grouping of vehicles 314a-314c.

It is understood that in a case wherein the infrastructure system 110 is configured to communicate to the hub vehicle (e.g., the first vehicle 102a, the second vehicle 102b, and/or the third vehicle 102c), the hub vehicle (e.g., the first vehicle 102a, the second vehicle 102b, and/or the third vehicle 102c) is then configured to broadcast one or more signals (e.g., received from the infrastructure system 110) to each vehicle within the grouping of vehicles respective to the hub vehicle (e.g., the first vehicle 102a, the second vehicle 102b, and/or the third vehicle 102c). In one or more examples, such a method of distributing the one or more signals originating from the infrastructure system 110 reduces communication-related delays as well as communication-related issues in general. It is also understood that the number of vehicles within the grouping of vehicles 314a-314c may vary based on the congestion associated with the communication-related traffic.

In one or more examples, the infrastructure-side AVM algorithm 112 is configured to control (e.g., cadence) communication(s) originating from the hub vehicle (e.g., the first vehicle 102a, the second vehicle 102b, and/or the third vehicle 102c) to prevent peaks and troughs in data transfer, which reduces a possibility of overloading the infrastructure system 110 and/or the one or more communication nodes 310a-310c. As another example, the hub vehicle (e.g., the first vehicle 102a, the second vehicle 102b, and/or the third vehicle 102c) is configured to communicate (e.g., transmit and/or receive one or more signals) with a particular communication node of the one or more communication nodes 310-310c based on a location of the hub vehicle (e.g., the first vehicle 102a, the second vehicle 102b, and/or the third vehicle 102c) in relation to the marshaling environment, which also reduces the possibility of overloading the infrastructure system 110 and/or the one or more communication nodes 310a-310c.

In one or more examples, the infrastructure-side AVM algorithm 112 is configured to evaluate each group of the grouping of vehicles 314a-314c for communication regularity in an instance wherein low-severity groups have non-constant requirements. As an example, a severity level associated with each group of the grouping of vehicles 314a-314c can indicate a risk including, but not limited to, operational interruptions or other identified critical use scenarios. As another example, a non-constant requirement can include actions such as, but not limited to, waiting for transport or to receive marshaling instructions. As a further example, and in an instance wherein the infrastructure-side AVM algorithm 112 determines that a low-severity group of the grouping of vehicles 314a-314c has one or more non-constant requirements, the infrastructure-side AVM algorithm 112 is configured to assign the hub vehicle (e.g., the first vehicle 102a, the second vehicle 102b, and/or the third vehicle 102c) to be the recipient of all communication(s) transmitted from the infrastructure system 110.

As yet another example, the hub vehicle (e.g., the first vehicle 102a, the second vehicle 102b, and/or the third vehicle 102c) is configured to implement a batch process to communicate one or more signals from the respective one or more additional vehicles 142a-142c to the infrastructure system 110 at a pre-determined regularity (e.g., at pre-defined time intervals). For example, the predetermined regularity can be based on the congestion associated with the communication-related traffic. As another example, the batch process can include the hub vehicle (e.g., the first vehicle 102a, the second vehicle 102b, and/or the third vehicle 102c) collecting one or more signals from the respective one or more additional vehicles 142a-142c and transmitting all the collected one or more signals to the infrastructure system 110 at the predetermined regularity. In one or more examples, the batch process and associated vehicle control and/or movement limits the demand on independent vehicles transmitting at frequencies that could otherwise build across an unlimited number of vehicles in an instant and instead reduces such a flow of communication by moderating communication from different groups of vehicles in an organized fashion without causing operational gaps or communication-related interruptions.

The infrastructure-side AVM algorithm 112 is also configured to assign each individual classification of the one or more classifications with a communication regularity score. In one or more examples, the communication regularity score can identify a need for each individual classification of the one or more classifications to communicate with the infrastructure system 110. The communication regularity score, for example, can also serve as a basis for the infrastructure-side AVM algorithm 112 to differentiate one or more communication states associated with each individual classification of the one or more classifications. As another example, the one or more communication states can include a constant state, an intermittent state, a passive state, or an alert-only state. It is understood, however, that the one or more communication states can include any other communication regularity state and is not limited to the constant state, the intermittent state, the passive state, and/or the alert-only state. It is also understood that one or more communication state requirements associated with the vehicle 102 (e.g., and/or the one or more additional vehicles 142), locations associated with the vehicle 102 (e.g., and/or the one or more additional vehicles 142), and/or classifications associated with the vehicle 102 (e.g., and/or the one or more additional vehicles 142) can dynamically change based on a level of measured (e.g., by the infrastructure-side AVM algorithm 112) communication-related traffic.

The infrastructure-side AVM algorithm 112 is further configured to assign each individual classification of the one or more classifications with a severity score. In one or more examples, the severity score can indicate a risk including, but not limited to operational interruptions or other identified critical use scenarios. As another example, the severity score can also indicate a priority-listing of certain vehicles assigned to a general classification or to each category of the one or more classifications to receive one or signals from either the vehicle 102 (e.g., the first vehicle 102a, the second vehicle 102b, and/or the third vehicle 102c) or infrastructure system 110.

The infrastructure-side AVM algorithm 112 is additionally configured to assign to each individual vehicle a communication-related score, which can include, but is not limited to, the communication regularity score, the severity score, or a combination thereof. In one or more examples, the infrastructure-side AVM algorithm 112 is configured to further group (e.g., associate) vehicles within a general classification or to each category of the one or more classifications related to the assigned communication-related score(s) provided to each individual vehicle. As another example, the infrastructure-side AVM algorithm 112 is also configured to further group (e.g., associate) vehicles based on proximity of each vehicle from surrounding vehicles, a use associated with each vehicle, as well as any other vehicle-related metric associated with communicating with the infrastructure system 110. For example, and based on the communication-related score, vehicles can move from one group to another group of the grouping of vehicles 314a-314c. In other words, groups as well as individual vehicles can enter and/or exit different classifications or categories of the one or more classifications as the vehicle(s) transition between one or more uses or one or more locations within the marshaling environment, for example.

In one or more embodiments, each vehicle within the grouping of vehicles 314a-314c is configured to identify a presence of one or more anomalies. In a case wherein the one or more anomalies (e.g., communication or transmission anomalies) is identified, a direct communication between the identifying vehicle and the infrastructure system 110 and/or the one or more communication nodes 314a-314c is triggered. In one or more examples, and in response to the identification of the presence of the one or more anomalies, both the identifying vehicle as well as the infrastructure-side AVM algorithm 112 are configured to classify and/or identify one or more locations where an increased number of anomalies are present within the marshaling environment and identify and/or aggregate a root cause so that any issues associated with the one or more anomalies can be prevented in the future. For example, the infrastructure-side AVM algorithm 112 as well as the vehicle-side AVM algorithm 122 are both configured to perform an aggregation of one or more anomalies (e.g., or data associated with the detection of the one or more anomalies) to determine one or more areas within the marshaling environment that correspond to varying assemblages of the one or more anomalies.

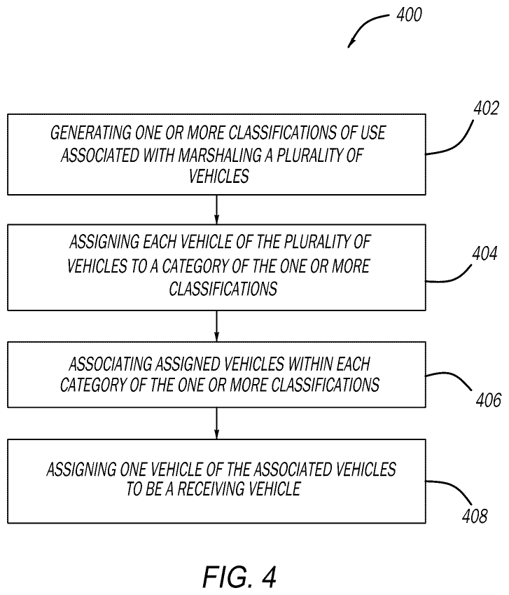

FIG. 4 is a flowchart illustrating an example method 400 for providing a means for managing communication-related traffic within a marshaling environment. At operation 402, an infrastructure system (e.g., the infrastructure system 110) is configured to generate one or more classifications of use associated with marshaling a plurality of vehicles (e.g., the vehicle 102 and/or the one or more additional vehicles 142). For example, the one or more classifications of use include a monitoring state, a moving state, a transition state, a station operation, or a combination thereof.

In one or more examples, the generation of the one or more classifications of use includes storing one or more historical commands associated with each vehicle of the plurality of vehicles as well as predicting one or more feedforward commands. As another example, the prediction of the one or more feedforward commands is based on the one or more historical commands. As a further example, the prediction of the one or more feedforward commands corresponds to a future route each vehicle of the plurality of vehicles is to travel. Alternatively, and as an additional example, the prediction of the one or more feedforward commends corresponds to a parking area each vehicle of the plurality of vehicles is to park.

At operation 404, the infrastructure system is also configured to assign each vehicle of the plurality of vehicles to a category of the one or more classifications. In one or more examples, the assignment of each vehicle of the plurality of vehicles to the category of the one or more classifications is based on a location of each vehicle, a duration of state associated with each vehicle, one or more communication requirements associated with each vehicle, or a combination thereof.

At operation 406, the infrastructure system is additionally configured to associate the assigned vehicles within each category of the one or more classifications. In one or more examples, the association of the assigned vehicles within each category of the one or more classifications is based on one or more communication-related scores. As another example, the one or more communication-related scores include a regularity score, a severity score, or a combination thereof. As yet another example, the assigned vehicles are grouped within any of the grouping of vehicles 314a-314c.

At operation 408, the infrastructure system is further configured to assign one vehicle of the associated vehicles to be a receiving vehicle (e.g., the hub vehicle-the first vehicle 102a, the second vehicle 102b, and/or the third vehicle 102c vehicle). In one or more examples, the receiving vehicle is configured to receive one or more signals from the infrastructure system. As another example, the receiving vehicle is also configured to broadcast the one or more signals to other associated vehicles. As a further example, broadcasting the one or more signals from the receiving vehicle to the other associated vehicles is based on a cellular communication traffic exceeding a calibrated threshold. For example, the calibrated threshold is a ratio of a number of vehicles directly communicating with the central server (e.g., the infrastructure system 110) to a number of vehicles not directly communicating with the central server that can correspond to a predefined signal quality, as is described herein.

In one or more embodiments, the infrastructure system is configured to determine whether a cellular communication traffic is below the calibrated threshold. The infrastructure system is also configured to transmit the one or more signals to each vehicle of the associated vehicles in response to determining that the cellular communication traffic is below the calibrated threshold.

In one or more embodiments, the infrastructure system is configured to assign the regularity score to each vehicle of the plurality of vehicles as well as assign the severity score to each vehicle of the plurality of vehicles.

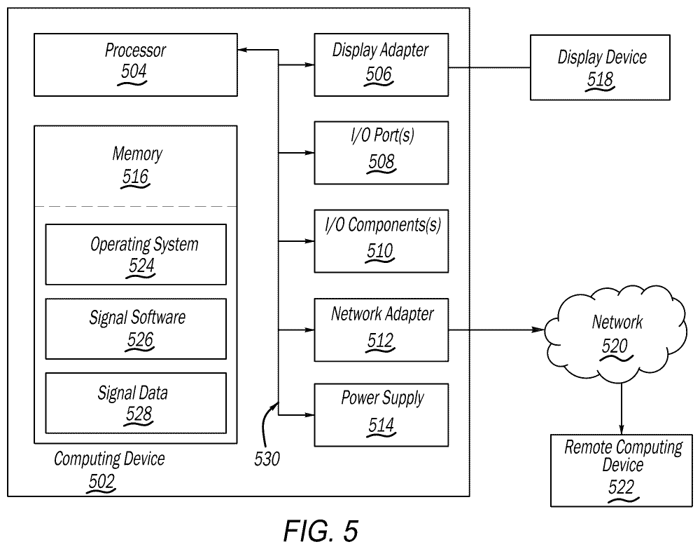

FIG. 5 illustrates an operating environment, such as a computer system, that facilitates the performance of the one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522. For example, the remote computing device 522 can be a user device such as a cellular-phone, a smartphone, a tablet, a laptop, or a combination thereof. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, random access memory (RAM), or a combination thereof. The memory 516 is configured to provide storage for instructions and data associated with the operation of the computing device 502. The memory 516 can generally include an operating system 524, signal software 526, and signal data 528. For example, the operating system 524 is configured to manage and/or process any of the data and/or instructions associated with the signal software 526 and/or signal data 528, as described in more detail herein, such as to manage communication-related traffic within the marshaling environment.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provide a means for managing communication-related traffic within a marshaling environment based at least on a batching process and the implementation of one or more machine learning techniques, as is described herein.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
generating, by an infrastructure system, one or more classifications of use associated with marshaling a plurality of vehicles;
assigning each vehicle of the plurality of vehicles to a category of the one or more classifications based on a location of each vehicle, a duration of state associated with each vehicle, one or more communication requirements associated with each vehicle, or a combination thereof;
associating the assigned vehicles within each category of the one or more classifications based on one or more communication-related scores; and
assigning one vehicle of the associated vehicles to be a receiving vehicle, wherein the receiving vehicle is configured to receive one or more signals from the infrastructure system and broadcast the one or more signals to other vehicles of the associated vehicles.

2. The method of claim 1, wherein generating the one or more classifications of use includes:
storing one or more historical commands associated with each vehicle of the plurality of vehicles; and
predicting, based on the one or more historical commands, one or more feedforward commands corresponding to a future route each vehicle of the plurality of vehicles is to travel or a parking area each vehicle of the plurality of vehicles is to park.

3. The method of claim 1, wherein the one or more classifications of use include at least one of a monitoring state, a moving state, a transition state, and a station operation.

4. The method of claim 1, wherein broadcasting the one or more signals from the receiving vehicle to the other vehicles of the associated vehicles is based on a cellular communication traffic exceeding a calibrated threshold.

5. The method of claim 1, further comprising:
determining whether a cellular communication traffic is below a calibrated threshold; and
transmitting, from the infrastructure system, the one or more signals to each vehicle of the associated vehicles in response to determining that the cellular communication traffic is below the calibrated threshold.

6. The method of claim 1, wherein the one or more communication-related scores include a regularity score, a severity score, or a combination thereof.

7. The method of claim 6, further comprising:
assigning the regularity score to each vehicle of the plurality of vehicles; and
assigning the severity score to each vehicle of the plurality of vehicles.

8. A system comprising:
an infrastructure system configured to:
generate one or more classifications of use associated with marshaling a plurality of vehicles,
assign each vehicle of the plurality of vehicles to a category of the one or more classifications based on a location of each vehicle, a duration of state associated with each vehicle, one or more communication requirements associated with each vehicle, or a combination thereof,
associate the assigned vehicles within each category of the one or more classifications based on one or more communication-related scores,
assign one vehicle of the associated vehicles to be a receiving vehicle, and
transmit one or more signals to the receiving vehicle; and
the receiving vehicle is configured to:
receive the one or more signals from the infrastructure system, and
broadcast the one or more signals to other vehicles of the associated vehicles.

9. The system of claim 8, wherein the infrastructure system configured to generate the one or more classifications of use is further configured to:
store one or more historical commands associated with each vehicle of the plurality of vehicles; and
predict, based on the one or more historical commands, one or more feedforward commands corresponding to a future route each vehicle of the plurality of vehicles is to travel or a parking area each vehicle of the plurality of vehicles is to park.

10. The system of claim 8, wherein the one or more classifications of use include at least one of a monitoring state, a moving state, a transition state, and a station operation.

11. The system of claim 9, wherein broadcasting the one or more signals from the receiving vehicle to the other vehicles of the associated vehicles is based on a cellular communication traffic exceeding a calibrated threshold.

12. The system of claim 8, wherein the infrastructure system is further configured to:
determine whether a cellular communication traffic is below a calibrated threshold; and
transmit the one or more signals to each vehicle of the associated vehicles in response to determining that the cellular communication traffic is below the calibrated threshold.

13. The system of claim 8, wherein the one or more communication-related scores include a regularity score, a severity score, or a combination thereof, and wherein the infrastructure system is further configured to:
assign the regularity score to each vehicle of the plurality of vehicles; and
assign the severity score to each vehicle of the plurality of vehicles.

14. The system of claim 8, wherein each vehicle of the other vehicles of the associated vehicles is configured to:
receive the broadcasted one or more signals from the receiving vehicle;
determine one or more anomalies within the broadcasted one or more signals; and
establish a communication link with the infrastructure system in response to the determination of the one or more anomalies, wherein the communication link provides for direct communication of the one or more signals between each vehicle of the other vehicles of the associated vehicles and the infrastructure system.

15. One or more non-transitory computer-readable media storing processor-executable instructions that, when executed by at least one processor, cause the at least one processor to:
generate, by an infrastructure system, one or more classifications of use associated with marshaling a plurality of vehicles;
assign each vehicle of the plurality of vehicles to a category of the one or more classifications based on a location of each vehicle, a duration of state associated with each vehicle, one or more communication requirements associated with each vehicle, or a combination thereof;
associate the assigned vehicles within each category of the one or more classifications based on one or more communication-related scores; and
assign one vehicle of the associated vehicles to be a receiving vehicle, wherein the receiving vehicle is configured to receive one or more signals from the infrastructure system and communicate the one or more signals to other vehicles of the associated vehicles.

16. The one or more non-transitory computer-readable media of claim 15, wherein the at least one processor caused to generate the one or more classifications of use is further caused to:
store one or more historical commands associated with each vehicle of the plurality of vehicles; and
predict, based on the one or more historical commands, one or more feedforward commands corresponding to a future route each vehicle of the plurality of vehicles is to travel or a parking area each vehicle of the plurality of vehicles is to park.

17. The one or more non-transitory computer-readable media of claim 15, wherein the one or more classifications of use include at least one of a monitoring state, a moving state, a transition state, and a station operation.

18. The one or more non-transitory computer-readable media of claim 15, wherein broadcasting the one or more signals from the receiving vehicle to the other vehicles of the associated vehicles is based on a cellular communication traffic exceeding a calibrated threshold.

19. The one or more non-transitory computer-readable media of claim 15, wherein the at least one processor is further caused to:
determine whether a cellular communication traffic is below a calibrated threshold; and
transmit, from the infrastructure system, the one or more signals to each vehicle of the associated vehicles in response to determining that the cellular communication traffic is below the calibrated threshold.

20. The one or more non-transitory computer-readable media of claim 15, wherein the one or more communication-related scores include a regularity score, a severity score, or a combination thereof, and wherein the at least one processor is further caused to:
assign the regularity score to each vehicle of the plurality of vehicles; and
assign the severity score to each vehicle of the plurality of vehicles.
